(19) United States
(12) Patent Application Publication
(10) Pub. No.: US 2004/0071997 A1
(43) Pub. Date: Apr. 15, 2004

(54) Tightened body tightening force stabilization agent, method for stabilization of tightening force using the stabilization agent, and tightened body component part coated with the stabilization agent

(76) Inventors: Kyoichi Komatsu, Tokyo (JP); Hiroshi Tsuji, Tokyo (JP); Naohiro Ishida, Tokyo (JP); Kazuhiro Ookubo, Tokyo (JP)

Correspondence Address: Kanesaka & Takeuchi, Suite 2, 1423 Powhatan Street, Alexandria, VA, 22314, US

(21) Appl. No.: 10/466,684

(22) PCT Filed: Jan. 28, 2002
(86) PCT No.: PCT/JP02/00587

(30) Foreign Application Priority Data
Jan. 31, 2001 (JP) 2001-24519

(51) Int. Cl. B05D 3/02

(52) U.S. Cl. 428/500; 427/372.2; 428/539.5

(57) ABSTRACT

A tightened body tightening force stabilization agent capable of minimizing a variation in torque coefficient suitable for controlling a tightened body tightening force by a torque method, comprising, as an active ingredient, a polymer of unsaturated chain hydrocarbon with a carbon quantity of four; a method for stabilization of tightened body tightening force, comprising the steps of applying the polymer to at least either of a thread part such as a bolt member and a washer and the threaded part or seat surface of the tightened body and performing a tightening operation.

### TECHNICAL FIELD

The present invention relates to a stabilization agent for stabilizing tightening force of tightened body, a method for stabilization of tightening force using the same, and component part that constitute tightened body and are pre-adhered with this stabilization agent. “Component parts that constitute tightened body (tightened-body constituent parts)” here include screw-threaded component such as bolt members formed with external threads and nut members formed with internal threads, e.g., bolts, screws, nuts, piping joints, and the like, as well as washers which are used supplementarily with tightened body, and other fastened members. This specification uses the terminology defined in the rules of tightening of screws (JIS B1083) and Screw Threads and Fasteners-Vocabulary (JIS B0101).

### BACKGROUND ART

JIS B1083 provides the rules of tightening of screws. The following is an outline of part of the rules relevant to the present invention. FIG. 8 is a graph showing the relationship between elongation of bolt and axial tension generated by tightening force. The elongation of bolt changes linearly with the axial tension generated by tightening force within the elastic range until it reaches the yield point. The relationship between tightening torque Tf and tightening force Ff within the elastic range is expressed by the following Equation 1:

Tf=Ts+Tw=K·Ff·d (Equation 1),

where K, Ts, and Tw are expressed as follows:

K=(1/2d)((P/π)+μs·d2·secα′+μwDw) (Equation 2),

Ts=(Ff/2)·((P/π)+μs·d2 secα′) (Equation 3),

and

Tw=(Ff/2)·μwDw (Equation 4).

In the case where the contacting bearing surface is circular (including the cases where washers are used), Dw in Equation 4 is obtained by the following Equation 5:

Dw=(2/3)·((Do3−Di3)/Do2−Di2)) (Equation 5).

Characters in the above equations respectively represent the following:

Dw: Equivalent diameter of friction torque on the bearing surface

Di: Internal diameter of contacting bearing surface

Do: External diameter of contacting bearing surface

Ff: Initial or non-initial tightening force

K: Torque coefficient

P: Thread pitch

Tf: Tightening torque

Ts: Torque of threaded portion

Tw: Torque of bearing surface

d: Nominal diameter of screw

d2: Pitch diameter of screw

α: Thread flank angle

α′: Thread flank angle in a perpendicular cross section (tan α′=tan α·cos β)

β: Thread lead angle

μs: Friction coefficient of threaded surface

μw: Friction coefficient of bearing surface

Tightening force control of tightened bodies is essential for applying a required tightening force to the tightened bodies. For such control, torque control method, angle control method, and yield controlled method are generally known. The torque control method has the advantage that it requires no special tightening tool because it only controls tightening torque during tightening operation, and therefore this method has found wide applications.

It has problems, however, that more or less 90% of tightening torque Tf is consumed by friction on the thread surface and bearing surface, and that initial tightening force is largely dependent on the state of friction and contact on the thread surface and bearing surface during the tightening operation.

That is, as expressed by the following modification (Equation 1′) of the previous Equation 1:

Ff=Tf/(K·d) (Equation 1′),

the tightening force (or axial tension generated by tightening force) Ff is proportional to tightening torque Tf and inversely proportional to the torque coefficient K and nominal diameter of screw d. If a large number of same tightened bodies are configured using bolt and nut members of the same standard and applying the same tightening torque Tf, provided that the torque coefficient K is constant, tightening force (or axial tension generated by tightening force) Ff of the tightened body is supposed to be always the same, because the nominal diameter of the screw d is basically identical (even with slight variations within tolerance limits). In actuality, however, the resultant tightening force is not necessarily always the same even though the tightened bodies are constructed with bolts and nuts of the same standard and tightened with the same tightening torque.

This is because the tightening force of tightened bodies consisting of bolt members and nut members is not only determined by friction, wear, or lubrication in general terms in the fields of mechanics and machining, but is also readily affected by the variety and peculiarity of friction and contact states on the thread surface and bearing surface. For example, local galling or seizure on the thread surface and bearing surface makes the friction state uneven and changes the torque coefficient. Variations in the tightening characteristics due to this problem lead to unstable tightening force.

That is, to achieve constant screw tightening force with the torque control method which controls tightening force thereby indirectly controlling the tightening force, the variety and peculiarity of friction or contact on the thread surface and bearing surface must be well taken into consideration, but local galling or seizure on the thread surface and bearing surface makes the friction state uneven and not only changes the friction coefficient thereon, but also has influence on other factors such as the equivalent diameter of friction torque on the thread surface or bearing surface and pitch diameter of screw, leading to variations in the tightening characteristics and varying tightening force.

FIG. 9 illustrates such a state as described above in which the axial tension generated by tightening force Ff changes with the variation of torque coefficient K. As can be seen, variations of tightening torque Tf in addition makes the difference between the minimum axial tension Ffmin and maximum axial tension Ffmax considerably large, which may well constitute a large inhibiting factor against invariant tightening force achieved by tightening operation.

Under these circumstances, various attempts have been made to achieve constant and invariant tightening force by controlling tightening torque.

The following are examples of prior art techniques for stabilizing the tightening force of tightened bodies by means of the torque control tightening.

(1) Method of applying machine oil or paste containing solid lubricant powder.

(2) Method of coating powder material such as molybdenum disulfide or PTFE (polytetrafluoroethylene or tetrafluoroethylene) with resin binder or the like (Japanese Patent Laid-Open Publications Nos. Sho 50-139256 and Hei 10-338824).

(3) Bonderlite and Bondalube treatment method (Japanese Patent Laid-Open Publication No. Sho 49-81237).

(4) Method of dry coating water-dispersed oxidized low molecular weight polyethylene and synthetic resin emulsion by immersion therein or application thereof (Japanese Patent Laid-Open Publication No. Hei 9-40991).

(5) Method of applying and coating graphite powder with epoxy resin or the like (Japanese Patent Laid-Open Publications Nos. Hei 08-028535 and 2000-120638).

(6) Method of applying and dry coating water-dispersed/soluble resin.

The method (6) is disclosed in Japanese Patent Laid-Open Publications Nos. Sho 52-081462, Sho 52-149566, Sho 55-060711, Sho 55-062985, Sho 56-041285, Hei 06-080983, and Hei 07-224824.

The term “stabilization agent” is used here in connection with the variation coefficient B of torque coefficient; average torque coefficient Km of tightening torque measured when the axial tension generated by tightening force is constant is obtained by the above Equation 1, and its variation is calculated from the following Equation 6 with a standard deviation Sk and variation coefficient B of torque coefficient. When the variation coefficient B of torque coefficient is relatively small, the tightening force is “stabilized,” whereas when it is large, the tightening force is “not stabilized.”

B=Sk/Km (Equation 6),

where

B: variation coefficient of torque coefficient,

Sk: standard deviation of torque coefficient,

Km: average torque coefficient.

In respect of this “stabilization”, the above prior art method (1) of simply applying mineral oil (machine oil) or the like or the method (2) of coating powders with resin binder cannot achieve stabilization of tightening force or torque coefficient sufficiently, and involve the problem of large thermal effects on tightening characteristics; while these methods are effective in reducing friction resistance, they are not for achieving the stabilizing effect, and thus cannot achieve the objects of the present invention.

That is, while the methods of adhering mineral oil or paste containing solid lubricant powder are effective in reducing friction resistance, these are not effective in achieving the above stabilization.

Further problems include high costs of the stabilization agent, and in the method of using solid lubricant powder, separation of solid powder and oil after standing due to the difference in specific gravity, and moreover, readily changeable or unstable tightening characteristics because of deformation or destruction of solid powder after the tightening or because of the setting effect after repeated tightening and loosening. “Repeated tightening and loosening” of tightened bodies may be necessary, for example, in repeated disassembling and assembling during maintenance performed in chemical or nuclear power plants or in aircraft or railway industries, or in repair of automobiles or replacement of tires.

The above methods (3) to (6) are used for stabilizing the tightening force of tightened bodies but have respective problems. For example, the Bonderlite and Bondalube treatment method has the problem of high sensitivity to temperature, i.e., the torque coefficient value varies largely with temperature changes.

The above method (4) of immersing or applying and drying water-dispersed oxidized low molecular weight polyethylene and synthetic resin emulsion (Japanese Patent Laid-Open Publication No. Hei 9-40991) has the following problems:

1) It does not use an organic solvent; it is hard to disperse the stabilizing substance in water evenly. Depending on the state of dispersion, there will be variations in the coating characteristics such as the thickness of film formed on tightened bodies, leading to varying torque coefficient.

2) If the coating agent were an organic solvent soluble type, tightened bodies could be used immediately after the spraying thereof because the solvent would volatilize. On the contrary, this method requires a drying apparatus for removing water, and even if the coating agent were aerosolized (sprayed), the tightened bodies could not be used immediately after the spraying in on-site applications.

The above method (5) of applying and coating graphite powder with epoxy resin or the like (Japanese Patent Laid-Open Publications Nos. Sho 08-028535 and 2000-120638) has the following problems: Graphite powder reduces friction coefficient and causes tightened bodies to loosen easily upon vibration or the like. Also, the torque coefficient varies largely depending on the state of dispersion and particle diameter of graphite powder.

The above method (6) of applying and dry coating water-dispersed/soluble resin (“solid coating type”) has the following problems:

a) Sufficient stabilization is not achieved.

b) Not suitable for small quantity production because of the need of special treatment equipment.

c) Coating film thickness affects the tightening characteristics.

d) Coating may peel by contact during transportation or tightening operation.

e) Coating may peel by repeated tightening and loosening, thus changing tightening characteristics.

f) Pre-adhered water or oil will change the tightening characteristics.

As described above, the prior art methods of stabilizing the tightened body tightening force are all problematic.

An object of the present invention is to overcome the above problems and to provide a tightening force stabilization agent for a tightened body which capable of minimizing a variation in torque coefficient suitable for controlling a tightened body tightening force by a torque method.

Another object of the invention is to provide a method of stabilizing tightening force of tightened bodies using this stabilization agent, whereby constant tightened body tightening force is invariably achieved.

Yet another object of the invention is to provide tightened body constituent parts pre-adhered with the stabilization agent for use in a situation where the above tightening force stabilization agent is adhered to tightened body constituent parts in a factory or the like where tightened body constituent parts are manufactured and/or handled before supplying same to other factory or the like where these parts are mechanically assembled into tightened bodies.

### DISCLOSURE OF THE INVENTION

The above objects of the present invention are achieved by various aspects of the invention described below. Note that “tightened bodies” in the present invention are the same as “screw threaded bodies” defined in JIS B1083.

(1) A tightened body tightening force stabilization agent comprising, as an active ingredient, a polymer of unsaturated chain hydrocarbon with a carbon quantity of four.

(2) The tightened body tightening force stabilization agent of the-above invention (1), wherein the polymer of unsaturated chain hydrocarbon with a carbon quantity of four is one of n-butene homopolymer, isobutene homopolymer, n-butene/isobutene copolymer, and a mixture of these.

(3) The tightened body tightening force stabilization agent of the above invention (1) or (2), wherein the active ingredient of the stabilization agent is compatibility dissolved in a mineral oil in an amount of 10 weight % or more.

(4) The tightened body tightening force stabilization agent of any of the above inventions (1) to (3), wherein the active ingredient of the stabilization agent is dissolved in an organic solvent.

(5) The tightened body tightening force stabilization agent of the above invention (1) or (2), wherein the active ingredient of the stabilization agent has a number average molecular weight of 5000 or less measured by ASTM D2503-92.

(6) The tightened body tightening force stabilization agent of the above invention (1) or (2), wherein the active ingredient of the stabilization agent has a weight average molecular weight of 50000 or more measured by an NPCC method (Nippon Petrochemicals Method: GPC method).

(7) The tightened body tightening force stabilization agent of any of the above inventions (1) to (6), wherein the stabilization agent is conditioned to have a viscosity of 235 mPa·s or more under tightened body tightening operation environment temperatures.

(8) A method for stabilization of tightening force of tightened bodies, wherein at least one of a thread portion of screw thread components such as bolt members and nut members, and fastened members, and a bearing surface of screw thread components such as bolt members and nut members, washers, and fastened members is adhered with the stabilization agent of any of the above inventions (1) to (7).

(9) A tightened body component part comprising the tightened body stored in a state wherein at least one of a thread portion and washer, screw thread portion or bearing surface of fastened members is pre-adhered with the tightening force stabilization agent of any of the above inventions (1) to (7).

(10) The tightened body component part comprising the tightened body of the above invention (9), wherein the active ingredient of the stabilization agent of any of the above inventions (1) to (3) or (5) to (7) is dissolved in an organic solvent, after which the organic solvent is volatilized to form a coat.

(11) The tightened body component part comprising the tightened body adhered with the tightening force stabilization agent of any of the above inventions (1) to (7) on the surface thereof, the tightened body component part being at least one of screw thread components such as bolt members and nut members, washers, and fastened members.

### BRIEF DESCRIPTION OF THE DRAWINGS

FIG. 1 is an electronic microscope image of the state of a washer bearing surface applied with the tightening force stabilization agent of example 38 containing butene polymer after tightening and loosening;

FIG. 2 is an electronic microscope image of the state of a washer bearing surface applied with the lubricant (machine oil) of comparative example 5 after tightening and loosening;

FIG. 3 is an electronic microscope image of a washer bearing surface applied with the lubricant (calcium compound solid lubricant containing paste) of comparative example 7 after tightening and loosening;

FIG. 4 is a graph showing the relationship between torque coefficient and viscosity of tightening force stabilization agent containing butene polymer in test example 2;

FIG. 5 is a graph showing the effects of tightening operation environment temperature on the torque coefficient with respect to the tightening force stabilization agent of example 1 containing butene polymer and lubricant or mineral oil of a comparative example;

FIG. 6 is a graph showing repeated tightening characteristics with respect to the tightening force stabilization agent of example 38 containing butene polymer, lubricant or machine oil, and calcium compound/molybdenum disulfide solid lubricant containing pastes of comparative examples;

FIG. 7 is a graph showing loosening characteristics with respect to the tightening force stabilization agent of example 7 containing butene polymer in comparison with lubricant or machine oil of a comparative example;

FIG. 8 is a graph showing the relationship between elongation of bolt and axial tension generated by tightening force; and

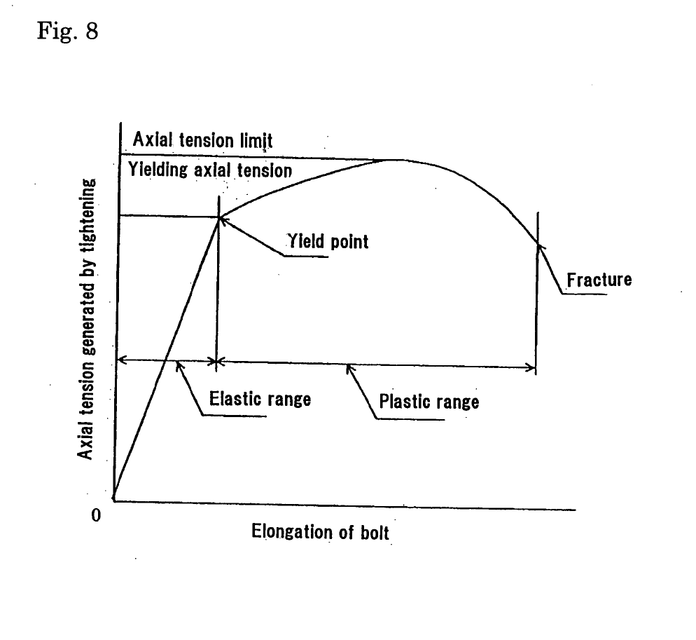

FIG. 9 is a graph showing the effects of change in torque coefficient on tightening torque and axial tension generated by tightening force.

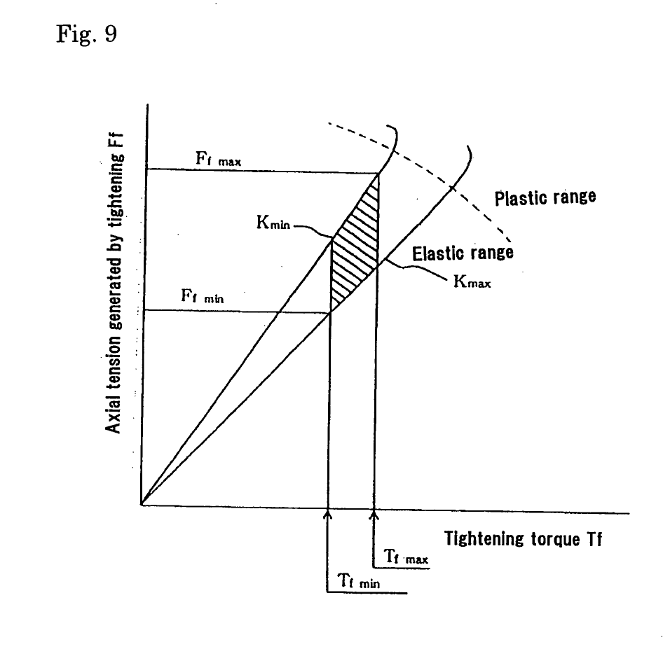

### BEST MODE FOR CARRYING OUT THE INVENTION

For the unsaturated chain hydrocarbon with a carbon quantity of four defined in the above invention (1), an olefinic hydrocarbon, butene (or referred to as butylene) including n-butene and isobutene, as specified in the above invention (2), should preferably be used. Polymer (polybutene) may be a polymerized compound having a single monomer unit (homopolymer), or a polymerized compound having both monomer units (copolymer). These homopolymers or copolymers may be used either alone or in combination. “Polybutene” or “polymer” in the following description includes homopolymer or copolymer and a mixture of these, unless otherwise specified in examples.

Generally speaking, polybutene used in the present invention should preferably have a number average molecular weight Mn of 300 or more and a viscosity average molecular weight Mv of 1×10⁷ or less, and more preferably a number average molecular weight Mn of 500 or more and a viscosity average molecular weight Mv of 6×10⁶ or less. If the average molecular weight is too small, the variation coefficient of torque coefficient to be described later tends to be large. Also, unsafety features increase because of the lowered flash point. On the other hand, if the average molecular weight is too large, the stabilizing substance will be hard, which leads to large friction resistance on the thread surface and bearing surface, and large torque coefficient. Moreover, too large an average molecular weight causes solidification of the stabilizing substance, which will crack by the force applied to the thread surface and bearing surface, resulting in large variations of torque coefficient.

Typical examples of such polybutene are Glissopal 1000, 1300, and 2300 manufactured by BASF Co., Ltd., having a weight average molecular weight of 1000 to 2300 measured by a gel permeation chromatography (GPC) method; Tetrax 3T, 4T, 5T, and 6T manufactured by Nippon Petrochemicals, Co., Ltd., having a weight average molecular weight of 66000 to 129000 measured by NPCCC method (GPC method); and Idemitsu Polybutene OH, 5H, and 2000H (hydrogenated grade) and 15R, 35R, 100R, and 300R (non-hydrogenated grade) manufactured by Idemitsu Petrochemical Co., Ltd., having a number average molecular weight of 350 to 3000 measured by ASTM D2503-92.

In order to avoid seizure of tightened bodies in high temperature applications, solid lubricant may be added and mixed to the tightened body tightening force stabilization agent of the invention.

In case of poor operability because of high viscosity and low adhesion, n-butene homopolymer, isobutene homopolymer, isobutene/n-butene copolymer, or a mixed composition of these may be dissolved in a suitable solvent to adjust the viscosity. Alternatively, a mixed composition containing two or more of n-butene homopolymer, isobutene homopolymer, and n-butene/isobutene copolymer may be used in the form of emulsion with an incompatible dispersion medium (such as water) and a surfactant.

The stabilization agent containing butene polymer (polybutene) as an active ingredient can be compatibility dissolved in a mineral oil and adhered on bolt members or the like, or dissolved in an organic solvent which is removed by drying before or after the adhesion thereof to the bolt members or the like. In the former case wherein mineral oil is used as a compatible solvent, it is preferable to mix 10 mass % or more of the active ingredient of stabilization agent in the mineral oil as specified in the above invention (3). If the dissolved amount is less than that, the variation coefficient tends to be large, rendering it difficult to achieve the objects of the invention. In the latter case wherein an organic solvent is used, various solvents, for example, toluene and hexane can be used, as long as they are volatile and compatible with butene polymer. In the case in which such an organic solvent is used, the solvent is removed by drying, as it is volatilizable. Examples of mineral oils include neutral oil, bright stock and the like obtained by distillation and separation of paraffin base, naphthene base, or intermediate base crude mineral oil followed by hydrogenation refinement or solvent refinement treatment, oils that have undergone distillation and extraction at constant pressure followed by a solvent de-waxing treatment, and oils obtained by removing impurities such as sulfide from these oils by hydrogenation refinement under high pressure. Mineral oils are not limited to these and other oils that are commonly used with screw tightening, particularly the machine oil (ISO VG46), may also be used.

It should go without saying that the stabilization agent of the present invention may also contain other additives for various purposes as required. Such additives may include, for example, extreme pressure additives, anti-foaming agents, colorants for easy visual recognition of the presence of adhered stabilization agent, and so on. These additives are generally added in a very small amount, so that their effects on the aforementioned variation coefficient B for the tightening force stabilization according to the invention are virtually negligible.

Coating layers of the stabilization agent of the invention adhered on thread surface or the like can form in various states such as liquid, soft viscous, and elastic depending on the difference in average molecular weight.

Elastic state mentioned in the invention includes a viscous and elastic states (excluding those in Table 5).

The difference in the state of the coating has a large bearing on the purposes for which the stabilization agent of the invention is used. For large number applications such as automobile industry, for example, it is unpractical in terms of operation efficiency to achieve adhesion of the stabilization agent in the operation site of tightened body production, and tightened body constituent parts should preferably be fabricated as stabilization agent-adhered products in the supplier's factory or the like and supplied. In such a case, the stabilization agent should preferably contain butene polymer having a weight average molecular weight of 50000 or more, which will take an elastic state when adhered on the surface of bolt members or the like. In small number applications, on the contrary, it is more preferable to achieve adhesion of the stabilization agent in the assembling operation site for the sake of the operability of adhesion on the bolt members or the like. Thus butene polymer having a number average molecular weight of 5000 or less is suitable, which will take a liquid state when adhered. Butene polymer having a weight average molecular weight of more than 5000 and less than 30000 may be used to benefit from both advantages in the applications where adhesion is achieved in factories and where it is achieved on site, i.e., respective effects of the above mentioned elastic coating layer (coat formed by butene polymer having a weight average molecular weight of 50000 or more) and liquid coating layer (formed by butene polymer having a number average molecular weight of 5000 or less) can both be enjoyed in a well-balanced manner.

In the case of using a mixture of n-butene, isobutene, n-butene homopolymer, isobutene homopolymer, and copolymer of these, the average molecular weight of each butene forming the mixture may be the same, or different. Using a mixture of butene polymers having largely different average molecular weights offers the advantage of wider ranges of viscosity and of adjusting stabilizing characteristics under various ambient temperatures of use. Also, butene polymers (polybutenes) having the same composition but different average molecular weights (e.g., isobutenes having average molecular weights of several thousands and several tens thousands) may be mixed, so as to widen the ranges of viscosity and of adjusting stabilizing characteristics under various ambient temperatures of use.

“Adhesion” of stabilization agent mentioned above should not be limited to specific techniques, as long as it achieves coating thereof on target surfaces (such as thread surfaces), and may be accomplished by any of application using a brush or the like, dipping, and spraying.

Depending on the surface condition of tightened body, extreme pressure additives (Re: “Lubrication Physicochemistry” p.226-229, 1974, Saiwai Shobo) or anti-foaming agents may be added td the tightened body tightening force stabilization agent of the invention, or other suitable additives may be added as long as they present no problem in respect of stabilization agent's characteristics. Also, colorants (such as pigments and dyes) may be added to the tightened body tightening force stabilization agent of the invention for facilitating visual recognition of the presence of adhered stabilization agent.

### EXAMPLES

Examples of the tightened body tightening force stabilization agent, method for stabilization of tightening force of tightened bodies, and tightened body component part coated with the stabilization agent according to the present invention will be hereinafter described with reference to the accompanying drawings, but the present invention is not limited to these examples.

Various different examples of tightening force stabilization agents, as well as lubricants and stabilization agents of comparative examples were respectively applied on bolts, nuts, and washers (hereinafter referred to as “bolts and others”), after which tightening tests were conducted with the following conditions A to F to compare the tightened body tightening force stabilizing characteristics. For the measurement of average molecular weight in the invention, ASTM D2503-92 was used for materials having a number average molecular weight Mn of 5000 or less, while the NPCC method (GPC method) was used for materials whose number average molecular weight Mn exceeds 5000. Further, measurement for materials whose weight average molecular weight Mw is 100000 or more was conducted based on Staudinger Index, which represents viscosity average molecular weight Mv, obtained by the BASF method. As for example 1, however, it is based on the weight average molecular weight Mw (measured by the BASF method: GPC method).

(1) The variation coefficient value B of torque coefficient given by the above Equation 6 that represents the degree of stabilization of tightened body tightening force was determined by the test with the following conditions.

Tightening Test Conditions

Standard screw thread tightened bodies:

Nominal of bolt is hexagonal headed bolt M16 (pitch 2 mm)

Hexagonal double-chamfered nut M16 (pitch 2 mm)

Bolt strength criteria: 8.8

Nut strength criteria: 8

Washer: plain washer used (HRC 40±5)

Screw thread tightened body surface treatment: zinc plate-chromate treatment (JIS H8610 Type 1B, Grade 3: chromate treatment)

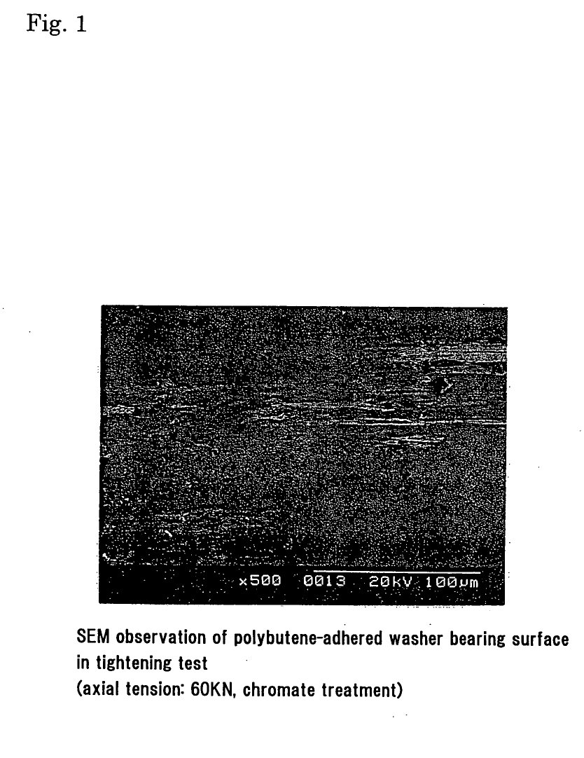

Axial tension generated by tightening force: 80 KN (except for Table 7, FIGS. 1-3, 6, and 7)

The tightened body and measurement equipment were set up and left for more than one hour after the room temperature has reached a preset fastening operation environment temperature; the tightening test was then started.

(2) For the isobutene (isobutylene) homopolymer, or polyisobutylene, used as the active ingredient of the stabilization agent, Glissopal (trade name) and Oppanol (trade name) manufactured by BASF Co., Ltd. are available on the market. Glissopal and Oppanol were used in some examples.

(3) For the isobutene or n-butene homopolymer, i.e., polybutene, used as the active ingredient of the stabilization agent, Tetrax (trade name), Himol (trade name), Evertack (trade name), Nisseki Polybutene (trade name), SV-7000 (trade name) manufactured by Nippon Petrochemicals Co., Ltd., VISTANEX (trade name) manufactured by ExxonMobil Corp., Idemitsu Polybutene (trade name) manufactured by Idemitsu Petrochemical Co., Ltd., Polyvis (trade name) manufactured by NOF Corp., Indopol (trade name) manufactured by Amoco Corp., and Napvis (trade name) manufactured by BP p.l.c. are available on the market. Of these, Tetrax and Idemitsu Polybutene were used in some examples.

(4) Mixed compositions of polyisobutene specified under above (2) and polybutene specified under above (3) were also used.

(5) The tightening force stabilization agent of the invention can comprise any one of isobutene homopolymer, n-butene homopolymer, isobutene/n-butene copolymer, or a mixture of two or more of these. In the case of using mixtures, various combinations of polymers having different viscosities are possible as shown in the margins of Tables 2 and 3. Table 2 shows examples 1 to 12 in which polybutene was adhered to form a coat without being dissolved in organic solvent, and Table 3 shows examples 13 to 27 in which polybutene was used with machine oil (ISO VG46) as a compatible solvent, with the mixture proportions as specified therein.

(6) Mineral oil (machine oil) or ISO VG46 which is generally used as a lubricant for screw tightening was used for comparative example 1. For the solid lubricant containing paste of comparative example 2, a lubricating agent containing calcium compound solid lubricant (Solvest 103 manufactured by STT Co., Ltd.) was used. For the water soluble resin dry coat used as the stabilization agent of comparative example 3, a “torquer treatment” product such as Torquer CHA green (manufactured by NOF Corp.) was used. For comparative example 4, epoxy resin (Epikote 828 manufactured by Japan Epoxy Resins Co., Ltd.) was used.

Table 1 below shows the tightened body tightening force stabilizing characteristics (specifically, the variation coefficient B of torque coefficient) of the lubricants and stabilization agents of prior art examples obtained by the tightening test with the above conditions or settings of (1) to (6) Tables 2 and 3 below show the tightened body tightening force stabilizing characteristics (the variation coefficient B of torque coefficient) of the tightening force stabilization agents of various examples of the invention obtained by the tightening test. Note that in the cases where polymers are “mixed” in Tables 2 and 3, they are compatible with each other.

TABLE 1
Tightened body tightening force stabilizing characteristics of
conventional products

| | | Standard | Variation | |
|---|---|---|---|---|
| | | deviation | coefficient | Av rag |
| | | of torque | of torque | torque |
| | | coefficient | coefficient | coefficient |
| Comparative | Machine oil | 0.0117 | 0.0636 | 0.184 |
| example 1 | | | | |
| Comparative | Solid lubricant | 0.00743 | 0.0663 | 0.112 |
| xample 2 | containing paste | | | |
| Comparative | Water soluble | 0.0200 | 0.0800 | 0.250 |
| example 3 | resin dry coat | | | |
| Comparative | Epoxy resin | 0.0188 | 0.0637 | 0.295 |
| example 4 | | | | |

Axial tension: 80 KN, Surface treatment: Chromate treatment, Screw nominal diameter M16 (pitch 2 mm), Tightening operation environment temperature: 24° C. in all cases
Conventional products
Comparative example 1: ISO VG46 machine oil (Cumic machine 46/Shin-nihon Yushikogyo Co., Ltd.)
Comparative example 2: Calcium compound solid lubricant containing paste (Solvest 103/STT Co., Ltd.)
Comparative example 3: Water soluble resin dry coat (Torquer CAH green/NOF Corp.)
Comparative example 4: Epoxy resin (Epikote 828/Japan Epoxy Resins Co., Ltd)

TABLE 2
Tightened body tightening forc stabilizing characteristics of butene polymers

| | | | | | | Viscosity of | | |
|---|---|---|---|---|---|---|---|---|
| | | Tightening | | | | stabilization | | |
| | | operation | Standard | Variation | | agent under | | |
| | | environment | deviation of | coefficient of | Average | operation | Average | |
| | Stabilization | temperature | torque | torque | torque | environment | molecular | Average molecular |
| | agent (mass %) | (° C.) | coefficient | coefficient | coefficient | temperature | weight | weight test method |
| Example 1 | 100% X | 24 | 0.0023 | 0.0145 | 0.159 | 14700 | 1000 | GPC |
| Example 2 | Mixture of 50% | 24 | 0.00205 | 0.0126 | 0.163 | 44700 | | |
| | X1 and 50% X2 | | | | | | | |
| Example 3 | Mixture of 62% | 24 | 0.00386 | 0.0252 | 0.153 | 21900 | | |
| | Y1 and 38% Y2 | | | | | | | |
| Example 4 | Mixture of 15% | 24 | 0.00304 | 0.019 | 0.16 | 25100 | | |
| | Z1 and 85% Y1 | | | | | | | |
| Example 5 | 100% Y | 24 | 0.00293 | 0.0168 | 0.174 | 703000 | 3000 | ASTM D2503-92 |
| Example 6 | 100% Y | 5 | 0.00348 | 0.0187 | 0.186 | 212000 | 960 | ASTM D2503-92 |
| Example 7 | 100% Y | 24 | 0.00204 | 0.0128 | 0.16 | 25200 | 960 | ASTM D2503-92 |
| Example 8 | 100% Y | 5 | 0.00225 | 0.0135 | 0.167 | 16300 | 570 | ASTM D2503-92 |
| Example 9 | 100% Y | 24 | 0.00226 | 0.0148 | 0.153 | 2260 | 570 | ASTM D2503-92 |
| Example 10 | 100% Y | 40 | 0.00291 | 0.0182 | 0.16 | 628 | 570 | ASTM D2503-92 |
| Example 11 | 100% Y | 20 | 0.00639 | 0.0351 | 0.182 | 338 | 400 | ASTM D2503-92 |
| Example 12 | 100% Y | −2 | 0.0102 | 0.0502 | 0.203 | 215 | 350 | ASTM D2503-92 |

Axial force: 80 KN, Surface treatment Chromate treatment, Screw nominal diameter M16 (pitch 2 mm GPC: Mw (weight average molecular weight) ASTM D2503-92
Mn (number average molecular weight)
Stabilization agent
Example 1 X: Glissopal 1000 Bulk/BASF
Example 2 X1: Glissopal 1000 Bulk/BASF
X2: Glissopal 2300 Bulk/BASF
Example 3 Y1: Idemitsu polybutene 2000H/Idemitsu Petrochemical Co., Ltd.
Y2: Idemitsu polybutene OH/Idemitsu Petrochemical Co., Ltd.
Example 4 Z1: Tetrax 3T/Nippon Petrochemicals Co., Ltd.
Y1: Idemitsu polybutene 15R/Idemitsu Petrochemical Co., Ltd.
Example 5 Y: Idemitsu polybutene 2000H/Idemitsu Petrochemical Co., Ltd.
Example 6 Y: Idemitsu polybutene 100R/Idemitsu Petrochemical Co., Ltd
Example 7 Y: Idemitsu polybutene 100R/Idemitsu Petrochemical Co., Ltd.
Example 8 Y: Idemitsu polybutene 15R/Idemitsu Petrochemical Co., Ltd.
Example 9 Y: Idemitsu polybutene 15R/Idemitsu Petrochemical Co., Ltd.
Example 10 Y: Idemitsu polybutene 15R/Idemitsu Petrochemical Co., Ltd.
Example 11 Y: Idemitsu polybutene 5H/Idemitsu Petrochemical Co., Ltd.
Example 12 Y: Idemitsu polybutene OH/Idemitsu Petrochemical Co., Ltd.

TABLE 3
Tightened body tightening force stabilizing characteristics of stabilizers
containing butene polymers and machine oil

| | Proportion of | Standard | Variation | | Viscosity of |
|---|---|---|---|---|---|
| | stabilizer (mass %) | deviation of | coefficient of | Average torque | stabilizer at 24° C. |
| | added to machine oil | torque | torque | coefficient | (mPa · s) |
| Example 13 | 5% X | 0.00788 | 0.0532 | 0.148 | 220 |
| Example 14 | 10% X | 0.00476 | 0.0338 | 0.141 | 617 |
| Example 15 | 30% X | 0.00311 | 0.0258 | 0.121 | 9820 |
| Example 16 | 50% X | 0.00297 | 0.0234 | 0.127 | 121000 |
| Example 17 | 70% X | 0.00293 | 0.0205 | 0.143 | 1170000 |
| Example 18 | 5% Y | 0.00938 | 0.0572 | 0.164 | 133 |
| Example 19 | 10% Y | 0.00519 | 0.0338 | 0.154 | 235 |
| Example 20 | 30% Y | 0.00266 | 0.0213 | 0.125 | 1411 |
| Example 21 | 50% Y | 0.00255 | 0.0202 | 0.126 | 7620 |
| Example 22 | 70% Y | 0.00218 | 0.0159 | 0.137 | 43000 |
| Example 23 | 5% X + Y | 0.00816 | 0.0510 | 0.160 | 175 |
| Example 24 | 10% X + Y | 0.00295 | 0.0179 | 0.165 | 385 |
| Example 25 | 30% X + Y | 0.00239 | 0.0184 | 0.130 | 4560 |
| Example 26 | 50% X + Y | 0.00231 | 0.0174 | 0.133 | 35700 |
| Example 27 | 70% X + Y | 0.00313 | 0.0215 | 0.146 | 300000 |

Axial tension: 80 KN, Surface treatment: Chromate treatment, Screw nominal diameter M16 (pitch 2 mm),
Tightening operation environment temperature: 24° C. in all cases,
Viscosity of machine oil itself 95 mPa · s at 24° C.
Stabilization agent
X: Tetrax 3T/Nippon Petrochemicals Co., Ltd.
Y: Idemitsu polybutene 2000H/Idemitsu Petrochemical Co., Ltd.
X + Y: Mixture of 50% Tetrax 3T + 50% Idemitsu polybutene 2000H

As can be seen from Tables 1 to 3 above, while the variation coefficient B of torque coefficient (hereinafter referred to simply as “variation coefficient B”) exceeded 0.06 in comparative examples 1 to 3, it was less than 0.06 in the examples of the present invention wherein butene polymers were adhered on the bolts and others (see Table 2), and further, in the examples with polymers having a viscosity of 338 mPa·s or more, or an average molecular weight of 400 or more, the variation coefficient B was less than 0.04, and particularly, in the examples with polymers having a viscosity of 628 mPa·s or more, or an average molecular weight of 570 or more, the variation coefficient B was less than 0.02, indicating that excellent stabilizing effects were achieved; the test thus confirmed that variation was small.

In the examples of the present invention (see Table 3) in which butene polymers dissolved in compatible mineral oil were adhered on the bolts and others, the variation coefficient B showed tendency to decrease with an increase in the mixture proportion of butene polymers. The variation coefficient B was less than 0.04 when the mixture proportion was 10 mass % or more, and particularly, when the mixture proportion was 30 mass % or more, the variation coefficient B was less than 0.03, indicating that excellent stabilizing effects were achieved and variation was made small.

### Test Example 1

In order to ascertain what factors lead to the above measurement results, the state of the bearing surface of the washer, or tightened body component part was observed with an electronic microscope. FIGS. 1 to 3 show the results.

FIGS. 1 to 3 illustrate the states after the tightened bodies were tightened and loosened.

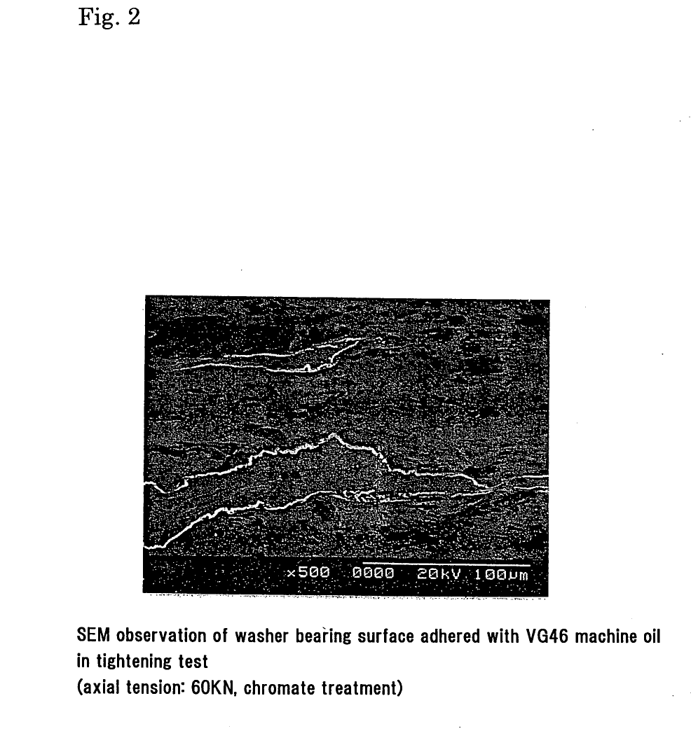

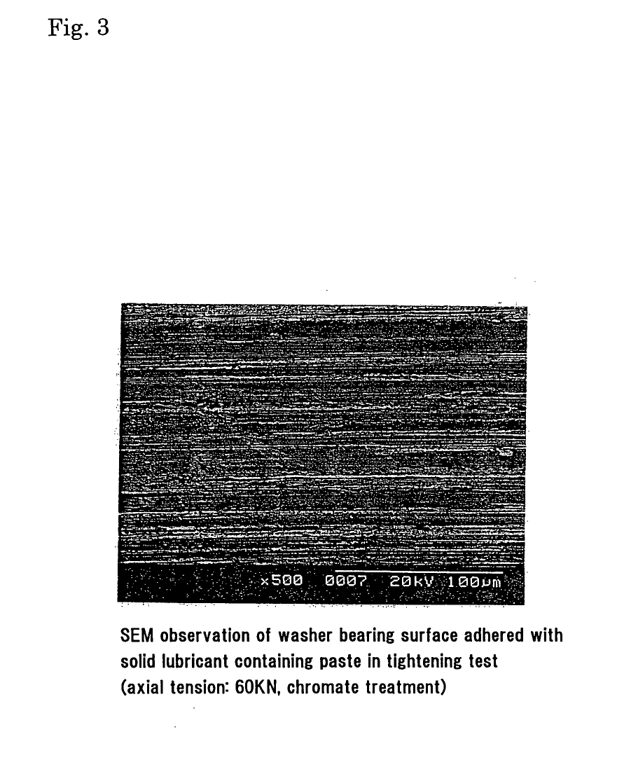

More specifically, the electronic microscope image of FIG. 1 shows the washer bearing surface when a stabilization agent having the same composition of example 38 was applied on the tightened body and dried, after which the tightened bodies was tightened with an axial tension of 60 KN. FIG. 2 shows an electronic microscope image of the washer bearing surface when the lubricant of comparative example 5 (machine oil) was applied on the tightened body, after which the tightened body was tightened with an axial tension of 60 KN. FIG. 3 shows an electronic microscope image of the washer bearing surface when the solid lubricant containing paste of comparative example 7 (calcium compound solid lubricant containing paste) was applied on the tightened body, after which the tightened bodies was tightened with an axial tension of 60 KN.

These electronic microscope images indicate the following: As shown in FIG. 2, part of the plated chromium layer (black portion) has disappeared on the washer bearing surface of the tightened body that was tightened after the application of mineral oil (machine oil); thus it is assumed that galling has occurred.

With respect to the washer bearing surface of the tightened body that was tightened after the application of solid lubricant containing paste of comparative example 7, linear scratches were observed all over the surface as shown in FIG. 3; these are assumed to have been made by hard solid lubricant rubbed against the surface.

Compared to these, in the example wherein the tightening force stabilization agent of the present invention was adhered, although part of the tightened washer bearing surface was severely rubbed as shown in FIG. 1, it is clearly seen that most of the chromium layer was retained (see black portion in FIG. 1).

Accordingly, these electronic microscope images show that the tightening force stabilization agent of the present invention is superior to the lubricant and others of the comparative examples in the tightening force stabilizing characteristics.

### Test Example 2

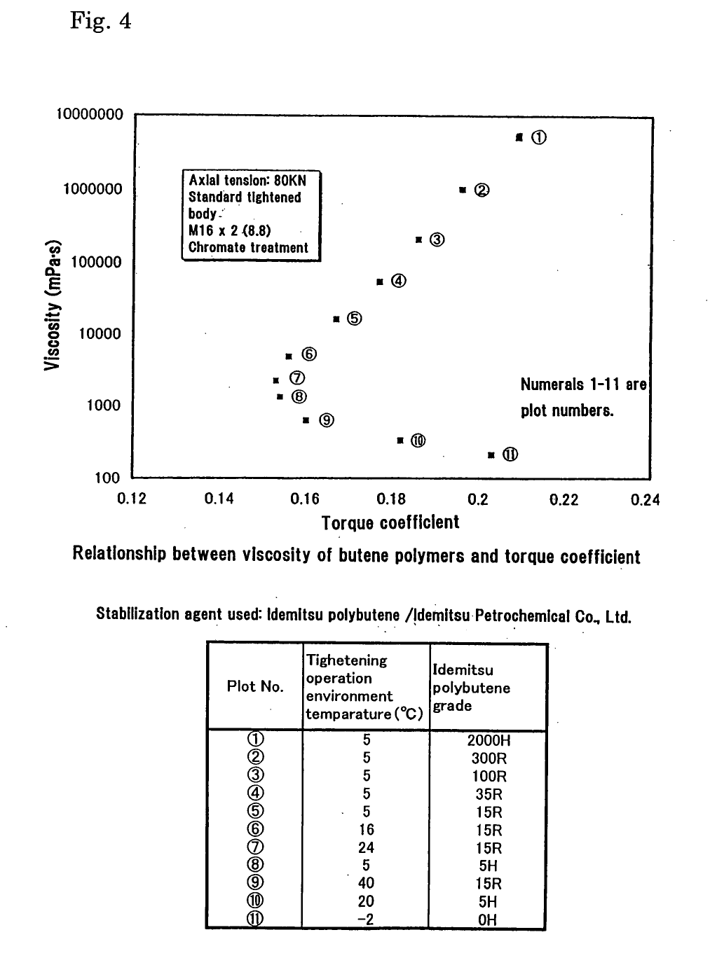

FIG. 4 is a graph indicating the relationship between the torque coefficient and viscosity of polybutene used in the tightening force stabilization agent of the examples.

The graph shows that there is a linear relationship between the logarithm of viscosity and the torque coefficient in the range in which viscosity is 2000 mPa·s or more. As can be seen from Table 3 above, the stabilization agents with a viscosity of 235 mPa·s or more have highly practicable, excellent properties, and desired variation reducing effects as compared with prior art examples. In addition to this, the stabilization agents offer the advantage that a desired torque coefficient can be achieved by adjusting the viscosity. Also, it will be seen from Table 2 that the stabilization agents offer the advantage of largely reducing the variation coefficient B in the range in which the viscosity is 630 mPa·s or more.

### Test Example 3

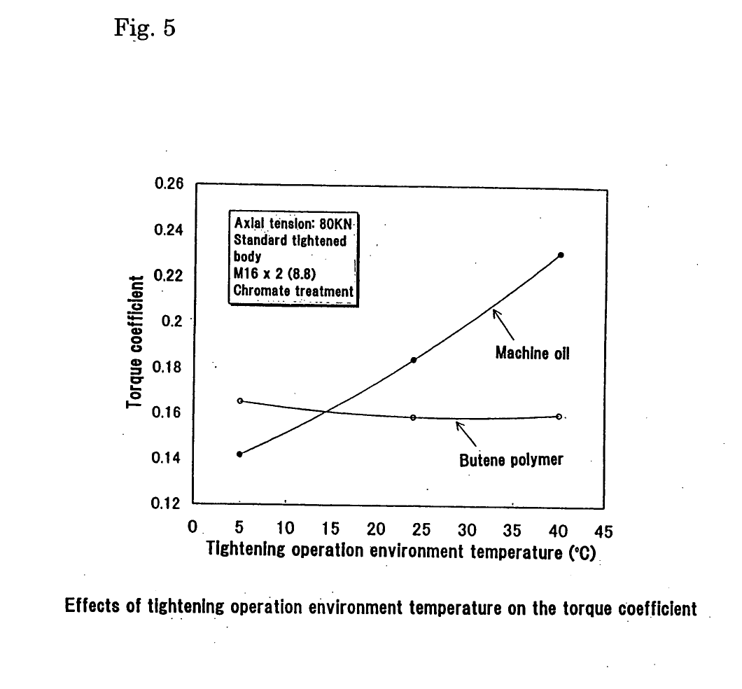

FIG. 5 is a graph illustrating test results of the effects of tightening operation environment temperatures on the torque coefficient, with respect to both cases in which the tightening force stabilization agent of example 1 was used (butene polymer: Glissopal 1000 Bulk/BASF) and the lubricant or machine oil of comparative example 1 was used (ISO VG46 machine oil: Cumic machine 46/Shin-nihon Yushikogyo Co., Ltd.)

It can be seen that, while the tightening force stabilization agent of example 1 exhibited very low tightening operation temperature dependency of torque coefficient, the torque coefficient varied largely in the case with the lubricant or machine oil of comparative example 1.

In conventional applications where the tightened body's axial tension generated by tightening force is controlled by controlling the tightening torque during tightened body tightening operation, not much consideration has been given to thermal effects. However, the temperature of the environment in which tightening operation is carried out can obviously change in an outdoor application such as a construction site. In such a case, therefore, the low temperature dependency of the variation coefficient B of torque coefficient can contribute largely to the stabilization of axial tension generated by tightening force when controlling the same by the torque control tightening.

### Test Example 4

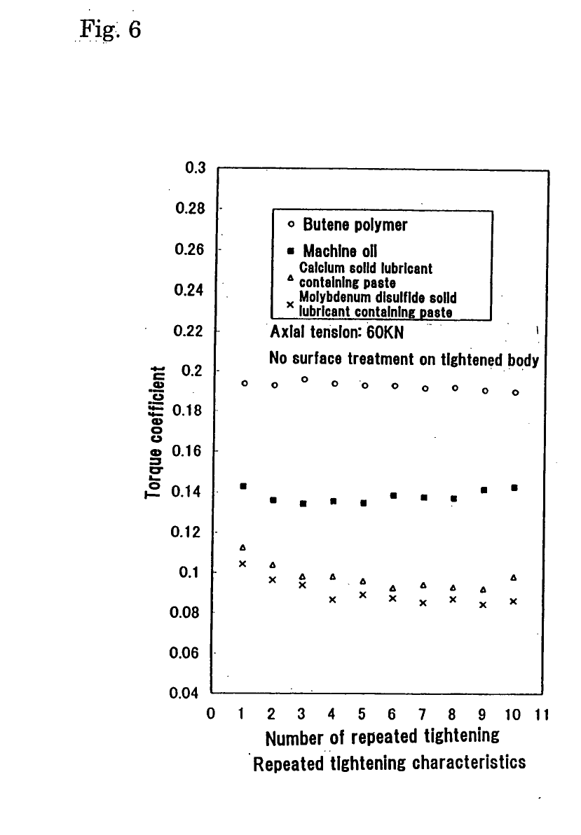

FIG. 6 is a graph illustrating the test results of repeated tightening characteristics, with respect to the cases in which the tightening force stabilization agent of example 38 was used (butene polymer: Idemitsu polybutene 100R/Idemitsu Petrochemical Co., Ltd.), machine oil of comparative example 5 was used (ISO VG46 machine oil: Cumic machine 46/Shin-nihon Yushikogyo Co., Ltd.), paste of comparative example 7 containing calcium compound substance was used (Solvest 103/STT Co., Ltd.), and molybdenum disulfide solid lubricant containing paste was used (Molykote G paste/Dow Corning Corp.). The tightening operation environment temperature was 24° C.

Tightened bodies can be used in applications where tightening and loosening thereof are repeated a number of times. A low torque coefficient will cause excessive tightening, whereas a high torque coefficient will result in insufficient tightening force, which may lead to a serious accident.

As can be seen from FIG. 6, after repeating the tightening ten times, the torque coefficient reduced largely with the repeated tightening, in the cases with the machine oil of comparative example 5 and solid lubricant containing paste of comparative example 7. This means that as the number of tightening increases, the tightening will tend to be excessive, applying too much load on the tightened bodies.

In contrast, in the case with the stabilization agent of example 7 of the present invention, there was little variation in the torque coefficient, meaning that it offers the advantage over the prior art examples in that the above problems will not occur.

### Test Example 5

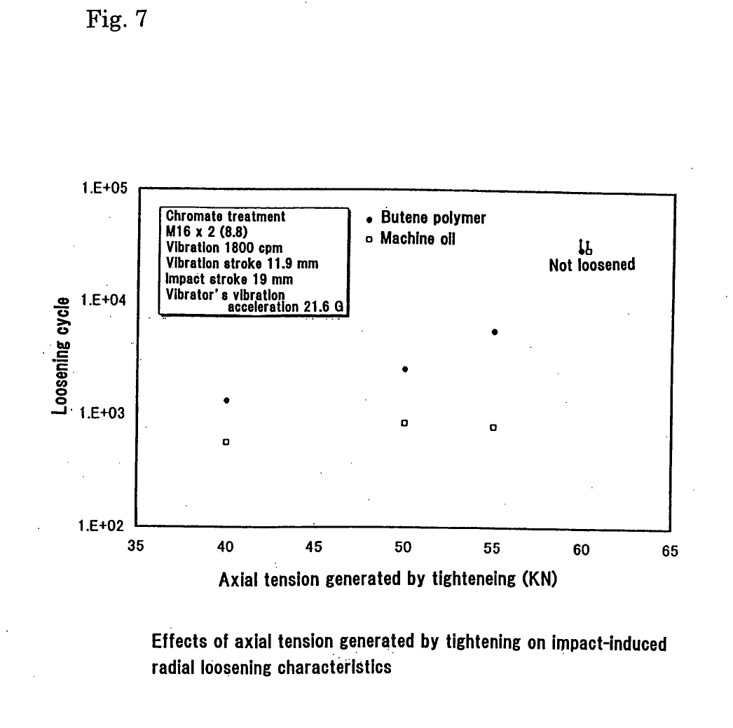

FIG. 7 is a graph illustrating the comparison test results of loosening characteristics with respect to both cases in which the tightening force stabilization agent of example 7 was used (butene polymer: Idemitsu polybutene 100R/Idemitsu Petrochemical Co., Ltd.), and the lubricant or machine oil of comparative example 1 was used (ISO VG46 machine oil: Cumic machine 46/Shin-nihon Yushikogyo Co., Ltd.).

As can be seen from the comparison test results, the tightened bodies loosen radically somewhere between the axial tension generated by tightening forces of 55 to 60 KN in the case with the lubricant or machine oil, whereas the tightened bodies loosen gradually with the decrease in the axial tension generated by tightening force in the case with the tightening force stabilization agent of example 7 of the invention.

Such a phenomenon caused by the products according to the invention will be very advantageous for the concepts of fault tolerant design practiced in the field of aircrafts, for example. That is, fault tolerant design aims at maintaining the safety of a structure by locating faults before they develop into a fatal stage by repeated service during use and carrying out suitable repair, on the presupposition that fault or failure exists from the beginning. The products according to the invention are superior to the prior art examples in the sense that even if the tightened bodies have loosened at some point, they will hardly have loosened to a fatal extent by the time of next service. Therefore, the application of the products according to the invention will offer much benefit and have large significance in the applications where safety is regarded as extremely important.

Next, the results of the test for ascertaining the effects of pre-adhered substance (such as water and oil) on the surface of tightened bodies on the stabilizing effect of the tightening force stabilization agents of the examples will be shown.

That is, it was examined what adverse effects there are on the stabilization of torque coefficient by the tightening force stabilization agent, if water or oil is adhered on the surface of the tightened body component parts such as bolts when the stabilization agent is adhered on the parts. Obviously, such effects are desired to be as small as possible. The results are shown in Table 4. Bolts and nuts were first entirely immersed in water or oil, after which, in a state where water or oil was not dripping, the stabilization agent was adhered.

TABLE 4
Effects of pre-adhered water or oil component on tightened body
surface on the tightened body tightening force stabilizing
characteristics of products according to the invention

| | | Standard | Variation | |
|---|---|---|---|---|
| | | deviation of | coefficient of | Average |
| | | torque | torque | torque |
| | | coefficient | coefficient | coefficient |
| Example 28 | Y only | 0.00204 | 0.0128 | 0.160 |
| Example 29 | Y adhered after | 0.00239 | 0.0155 | 0.154 |
| | adhesion of | | | |
| | machine oil | | | |
| Example 30 | Y adhered after | 0.00286 | 0.0174 | 0.164 |
| | adhesion of tap | | | |
| | water | | | |

Axial tension: 80 KN, Surface treatment: Chromate treatment, Screw nominal diameter M16 (pitch 2 mm), Tightening operation environment temperature: 24° C. in all cases
Stabilization agent
Y: Idemitsu polybutene 100 R/Idemitsu Petrochemical Co., Ltd.

As can be seen from the results, although the variation coefficient B of torque coefficient was slightly increased, it was confirmed that the stabilization agents of the invention could achieve a variation coefficient within an excellent range of less than 0.02, even if water or oil is adhered on the surface of tightened body component parts.

### Test Example 6

A further test was conducted to examine the difference in stabilizing characteristics depending on the state of the coating layer of the stabilization agent, which was formed by dissolving the stabilization agent in an organic solvent and adhered by application or the like on the surface of tightened body component parts such as bolts. The results are shown in Table 5 below (Note that the stabilization agents were dissolved in organic solvents only in this test).

(blank hereafter).

TABLE 5
Stabilizing characteristics of stabilizing substances dissolved in organic solvents and
adhered on tightened bodies, tested after volatilization of organic solvents

| | Average | | | | | |
|---|---|---|---|---|---|---|
| | molecular | | | Standard | Variation | |
| | weight of | State of | | deviation of | coefficient of | Average |
| | stabilization | stabilizing | Organic | torque | torque | torque |
| | agent | substance | solvent | coefficient | coefficient | coefficient |
| Example 31 | 4 × 10⁶ | Elastic | Toluene | 0.00623 | 0.0180 | 0.346 |
| Example 32 | 66000 | Soft | Toluene | 0.00311 | 0.0177 | 0.176 |
| | | viscous | | | | |
| Example 33 | 960 | Liquid | Hexane | 0.00191 | 0.0119 | 0.161 |

Axial tension: 80 KN, Surface treatment: Chromate treatment, Screw nominal diameter M16 (pitch 2 mm)
Method of adhesion on tightened bodies
Example 31: Immersion of tightened bodies in a solution of stabilizing substance in toluene, and standing for 6 hours in an atmosphere of 24° C. for the volatilization of the organic solvent
Example 32: Immersion of tightened bodies in a solution of stabilizing substance in toluene, and standing for 6 hours in an atmosphere of 24° C. for the volatilization of the organic solvent
Example 33: Spraying of a solution of stabilizing substance in hexane on tightened bodies, and standing for 6 hours in an atmosphere of 24° C. for the volatilization of the organic solvent
Stabilizing substance
Example 31: Oppanol B200/BASF
Example 32: Tetrax 3T/Nippon Petrochemicals Co., Ltd.
Example 33: Idemitsu polybutene 100R/Idemitsu Petrochemical Co., Ltd.
Molecular weight
Example 31: viscosity average molecular weight Mv (BASF method)
Example 32: weight average molecular weight Mw (GPC method/NPCC)
Example 33: number averag molecular weight Mn (ASTM D2503-92)

As can be seen from the results shown in Table 5, the coating layer of the products according to the invention having butene polymer as the active ingredient can take various different states such as elastic, liquid, and soft viscous on the surface of the tightened body component parts such as bolts depending on the polymerization degree of the polymer used (i.e., the average molecular weight), and it was confirmed that the variation coefficient B remained invariant and was maintained less than 0.02 in any case.

### Test Example 7

Table 6 shows the results of investigation of the effects of surface treatment on tightened bodies. The zinc plate-chromate treatment employed in the test was conducted according to JIS H8610 Type 1B, Grade 3. In the dacrotizing treatment, zinc particles and chromium compound were applied as a coat.

TABLE 6
Effects of surface treatment on tightened body tightening force
stabilizing characteristics

| | | Standard | Variation | |
|---|---|---|---|---|
| | | deviation | coefficient | Average |
| | | of torque | of torque | torque |
| | Surface treatment | coefficient | coefficient | coefficient |
| Example 34 | No surface | 0.00267 | 0.0134 | 0.199 |
| | treatment | | | |
| Example 35 | Zinc plate-chromate | 0.00230 | 0.0145 | 0.159 |
| | treatment | | | |
| Example 36 | Zinc plate-chromate | 0.00204 | 0.0128 | 0.160 |
| | treatment | | | |
| Example 37 | Dacrotizing | 0.00228 | 0.0142 | 0.161 |
| | treatment | | | |

Axial tension: 80 KN, Screw nominal diameter M16 (pitch 2 mm), Tightening operation environment temperature: 24° C. in all cases
Stabilization agent
Example 34: Idemitsu polybutene 100 R/Idemitsu Petrochemical Co., Ltd.
Example 35: Glissopal 1000 Bulk/BASF
Example 36: Idemitsu polybutene 100 R/Idemitsu Petrochemical Co., Ltd.
Example 37: Glissopal 1000 Bulk/BASF

As can be seen from the results shown in Table 6, it was confirmed that the variation coefficient B remained invariant.

### Test Example 8

Table 7 shows the results of investigation of the effects of axial tension generated by tightening force applied to tightened bodies.

TABLE 7
Effects of axial force on tightened body tightening force stabilizing
characteristics

| | | Standard | Variation | |
|---|---|---|---|---|
| | Test axial | deviation | coefficient | Average |
| | tension | of torque | of torque | torque |
| | (KN) | coefficient | coefficient | coefficient |
| Example 38 | 60 | 0.00185 | 0.0113 | 0.164 |
| Example 39 | 80 | 0.00204 | 0.0128 | 0.160 |
| Comparative | 60 | 0.0122 | 0.0667 | 0.183 |
| example 5 | | | | |
| Comparative | 80 | 0.0177 | 0.0636 | 0.184 |
| example 6 | | | | |
| Comparative | 60 | 0.00864 | 0.0771 | 0.112 |
| xample 7 | | | | |
| Comparative | 80 | 0.00743 | 0.0663 | 0.112 |
| example 8 | | | | |

Surface treatment: Chromate treatment, Screw nominal diameter M16 (pitch 2 mm), Tightening operation environment temperature: 24° C. in all cases
Stabilization agent
Examples 38, 39: Idemitsu polybutene 100 R/Idemitsu Petrochemical Co., Ltd.
Comparative examples 5, 6: Cumic machine 46/Shin-nihon Yushikogyo Co., Ltd.
Comparative examples 7, 8: Solvest 103/STT Co., Ltd.

As can be seen from the results shown in Table 7, it was confirmed that the variation coefficient B remained invariant irrespective of changes in the axial tension generated by tightening force.

### INDUSTRIAL APPLICABILITY

The following effects are achieved by the tightened body tightening force stabilization agent, method for stabilization of tightening force of tightened bodies, and tightened bodies adhered with the tightening force stabilization agent according to the present invention:

Effect 1: The variation coefficient B of torque coefficient is maintained extremely invariant, i.e., a stable axial tension generated by tightening force is invariably achieved from the same tightening torque.

Effect 2: Costs are lower as compared to solid lubricant containing pastes of the prior art examples.

Effect 3: Torque coefficient or variation coefficient B can be set in a desired range by changing the viscosity.

Effect 4: The variation coefficient B is hardly affected by changes in the tightening operation environment temperature.

Effect 5: Sudden loosening will hardly occur.

Effect 6: Stabilization agent coating does not readily peel off (as compared to conventional solid coating type)

Effect 7: Stable tightening force of tightened bodies is ensured even in the applications with repeated tightening and loosening.

Effect 8: No special equipment is necessary for adhering the stabilization agent on tightened bodies. Thus there are few limitations on the number and place of processing.

Effect 9: Insusceptible to coating film thickness unlike the conventional solid coating type.

Effect 10: Insusceptible to water or oil adhered on tightened bodies.

Effect 11: Readily adaptable to small quantity adhesion-processing of tightened bodies.

1. A tightened body tightening force stabilization agent comprising, as an active ingredient, a polymer of unsaturated chain hydrocarbon with a carbon quantity of four.

2. The tightened body tightening force stabilization agent according to claim 1, wherein the polymer of unsaturated chain hydrocarbon with a carbon quantity of four is one of n-butene homopolymer, isobutene homopolymer, n-butene/isobutene copolymer, and a mixture of these.

3. The tightened body tightening force stabilization agent according to claim 1 or 2, wherein the active ingredient of the stabilization agent is compatibility dissolved in a mineral oil in an amount of 10 weight % or more.

4. The tightened body tightening force stabilization agent of according to any of the claim 1 to 3, wherein the active ingredient of the stabilization agent is dissolved in an organic solvent.

5. The tightened body tightening force stabilization agent according to claim 1 or 2, wherein said active ingredient of the stabilization agent has a number average molecular weight of 5000 or less measured by ASTM D2503-92.

6. The tightened body tightening force stabilization agent according to claim 1 or 2, wherein said active ingredient of the stabilization agent has a weight average molecular weight of 50000 or more measured by an NPCC method (GPC method).

7. The tightened body tightening force stabilization agent according to any of claims 1 to 6, wherein the stabilization agent is conditioned to have a viscosity of 235 mPa·s or more under tightened body tightening operation environment temperatures.

8. A method for stabilization of tightening force of tightened bodies, wherein at least one of a thread portion of screw thread components such as bolt members and nut members, and fastened members, and a bearing surface of screw thread components such as bolt members and nut members, washers, and fastened members is adhered with the stabilization agent according to any of claims 1 to 7.

9. A tightened body component part comprising the tightened body stored in a state wherein at least one of a thread portion and washer, screw thread portion or bearing surface of fastened members is pre-adhered with the tightening force stabilization agent according to any of claims 1 to 7.

10. The tightened body component part comprising the tightened body according to claim 9, wherein the active ingredient of the stabilization agent according to any of claims 1 to 3 or 5 to 7 is dissolved in an organic solvent, after which the organic solvent is volatilized to form a coat.

11. The tightened body component part comprising the tightened body according to claims 9 or 10 adhered with said tightening force stabilization agent according to any of claims 1 to 7 on the surface thereof, the tightened body component part being at least one of screw thread components such as bolt members and nut members, washers, and fastened members.
